(19) United States
(12) Patent Application Publication
(10) Pub. No.: US 2005/0190170 A1
(43) Pub. Date: Sep. 1, 2005

(54) Method for driving liquid crystal display device

(76) Inventor: Yong Seob Shin, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 11/013,013

(22) Filed: Dec. 15, 2004

(30) Foreign Application Priority Data
Feb. 27, 2004 (KR) 2004-13304

(51) Int. Cl. G09G 5/00

(52) U.S. Cl. 345/204; 349/87

(57) ABSTRACT

In a field sequential color (FSC) type liquid crystal display device having a liquid crystal display panel, a source driver IC for applying data signals to the liquid crystal display panel, a gate driver IC for applying gate signals to the liquid crystal display panel, a timing controller for applying various kinds of control signals and data signals to the gate and source driver ICs, and a background light source, composed of red, green and blue LEDs, for implementing RGB colors, the method includes, in addressing data to the liquid crystal display panels according to an odd or even frame, addressing the data from an upper part to a lower part of the liquid crystal display panel in the odd frame, while addressing the data from the lower part to the upper part of the liquid crystal display panel in the even frame.

### BACKGROUND OF THE INVENTION

1. Field of the Invention

The present invention relates to a liquid crystal display, and more particularly to a method for driving a liquid crystal display device which can be adapted to products such as cellular phones, digital cameras, PDAs, etc., and which can realize a high resolution and a high color reproduction by sequentially applying RGB (Red, Green, Blue) data to a liquid crystal display panel and adjusting LEDs for RGB colors as a background light source to match the timing of the RGB data.

2. Description of the Prior Art

As generally known in the art, an FSC (Field Sequential Color) thin film transistor (TFT) liquid crystal display (LCD) device, as shown in FIG. 1, includes a liquid crystal display panel 100, having a plurality of gate lines and data lines crossing each other and thin film transistors arranged at crossing parts of the data lines and the gate lines, for driving a liquid crystal, a source driver IC 200 for generating drive signals for driving the data lines of the liquid crystal display panel 100, a gate driver IC 300 for generating drive signals for driving the gate lines of the liquid crystal display panel 100, and a timing controller 500 for generating drive signals for driving the gate driver IC 300 and load signals and data signals for driving the source driver IC 200.

Also, the FSC type LCD device further includes a plurality of R (Red) LEDs 401, G (Green) LEDs 402 and B (Blue) LEDs 403 as a background light source 400, and a memory 600 for storing and reading frame data.

In this case, the source driver IC 200 and the gate driver IC 300 receive a carry signal and a carry shift direction changeover signal from the timing controller 500, and shift a carry left and right (up and down) (in the drawing, a source carry shift direction changeover signal is not illustrated).

One frame data is divided into R, G and B sub-frames, and each frame has ⅓ of a main-frame time.

In order to sequentially send data to the source driver IC 200, the memory 600 is used. The timing controller 500 stores the data in the memory 600, and provides sequential RGB frame data and control signals for controlling the frame data.

In this case, a method of displaying an image of the respective sub-frames is as follows.

If a gate clock signal and a gate carry (or STV (Start vertical signal)) signal is generated from the timing controller 500, the first gate is open at a rising edge of the next gate clock, and data of the first line is loaded to the liquid crystal display panel 100.

Also, the second gate is open at a rising edge of the clock after the next, and data of the second line is loaded to the liquid crystal display panel 100. In this manner, the last (i.e., n-th) gate is open, and data of one sub-frame is loaded to the liquid crystal display panel 100.

Referring to FIG. 2, this operation will be explained in detail. As shown in FIG. 2, a main frame is composed of three sub-frames, that is, an R sub-frame 710, a G sub-frame 720 and a B sub-frame 730, and each sub-frame is composed of a loading time T_{L}, a waiting time T_{W} and a flashing time T_{F}. For example, after the data of the R sub-frame 710 is loaded, the waiting time T_{W} is secured in order to secure the time required for the liquid crystal to sufficiently react to the data loading.

When the liquid crystal sufficiently reacts to the data loading, the flashing of the R LEDs 401 is performed.

In the same manner as the R sub-frame 710, the flashing of the G LEDs 402 and the B LEDs 403 is then performed with respect to the G sub-frame 720 and the B sub-frame 730. Consequently, an image of the main frame is displayed on the liquid crystal display panel 100.

However, the conventional LCD device as described above has the following problems.

Since one frame is composed of RGB sub-frames, one sub-frame should be processed in ⅓ of the frame time.

For instance, in the case of a system clock of 60 Hz, one main-frame time is 16.7 ms, and one sub-frame time is 16.7/3=5.56 ms. This means that the sub-frame time is far shorter than the reaction time of the existing TN (Twisted Nematic) liquid crystal. Accordingly, it is difficult to secure a sufficient reaction time of the liquid crystal in a frame, and thus the flashing is performed before the liquid crystal sufficiently reacts to the data loading.

Typically, the gradation recognized by human's eyes in a gray pattern appears differently in accordance with a degree of reaction of the liquid crystal. If it is assumed that the data loading time is 2 ms, the waiting time is 2 ms, and the flashing time is 1.56, as shown in FIG. 3, there is a time difference of 2 ms between the data loading times of the upper lines and the lower lines. For reference, “A” indicates a liquid crystal reaction profile of the first gate line, and “B” indicates a liquid crystal reaction profile of the last gate line.

As a result, the liquid crystal of the first line starts its reaction after the first-line data is loaded, the total reaction time of the liquid crystal before the flashing operation becomes 4 ms, and the reaction time of the liquid crystal of the last line becomes 2 ms.

Due to such a difference, the degree of reaction of the liquid crystal is changed, and this causes differences in luminance and chrominance and causes non-uniform luminance and chrominance to appear in upper and lower parts of the liquid crystal display panel.

### SUMMARY OF THE INVENTION

Accordingly, the present invention has been made to solve the above-mentioned problems occurring in the prior art, and an object of the present invention is to provide a method for driving a liquid crystal display device that can realize a high resolution and a high color reproduction by solving the non-uniformity of luminance and chrominance occurring in upper and lower parts of the liquid crystal display.

In order to accomplish this object, there is provided a method for driving a field sequential color (FSC) type liquid crystal display device having a liquid crystal display panel, a source driver IC for applying data signals to the liquid crystal display panel, a gate driver IC for applying gate signals to the liquid crystal display panel, a timing controller for applying various kinds of control signals and data signals to the gate and source driver ICs, and a background light source, composed of red, green and blue LEDs, for implementing RGB colors, the method comprising, in addressing data to the liquid crystal display panels according to an odd or even frame, addressing the data from an upper part to a lower part of the liquid crystal display panel in the odd frame, while addressing the data from the lower part to the upper part of the liquid crystal display panel in the even frame.

It is preferable that the gate signals are sequentially applied to the liquid crystal display panel, starting from a first gate line to a last gate line, in the odd frame, while the gate signals are sequentially applied to the liquid crystal display panel, starting from the last gate line to the first gate line, in the even frame. Also, a carry shift direction of gates is set to be from the upper part to the lower part of the liquid crystal display panel in the odd frame, while the carry shift direction is set to be from the lower part to the upper part of the liquid crystal display panel in the even frame.

Preferably, RGB sub-frames are arranged as odd, even and odd sub-frames in sequence in the odd frame, while the RGB sub-frames are arranged as even, odd, and even sub-frames in sequence in the even frame.

Preferably, a gate left/right signal is used as a control signal for changing a data-addressing direction, and is for alternately changing the direction in synchronization with a vertical sync signal of the sub-frames.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a conventional FSC type liquid crystal display device;

FIG. 2 is a view provided for explaining a data-addressing direction according to the prior art;

FIG. 3 is a view provided for explaining the time difference between liquid crystal reactions of the first line and the last line according to the prior art;

FIG. 4 is a view provided for explaining a data-addressing direction according to a method for driving a liquid crystal display device according to the present invention;

FIG. 5 is a view provided for explaining the time difference between liquid crystal reactions of the first line and the last line according to a method for driving a liquid crystal display device according to the present invention; and

FIG. 6 is a timing diagram of a gate left/right signal for controlling the data-addressing direction according to the present invention.

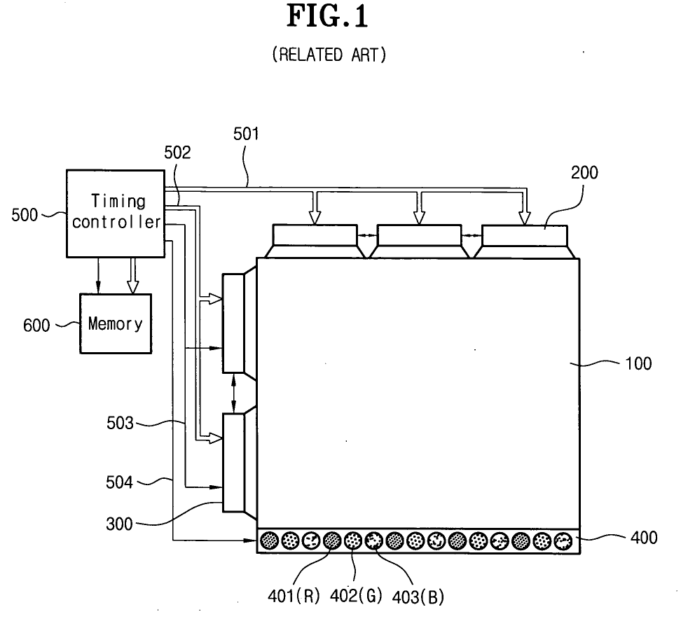

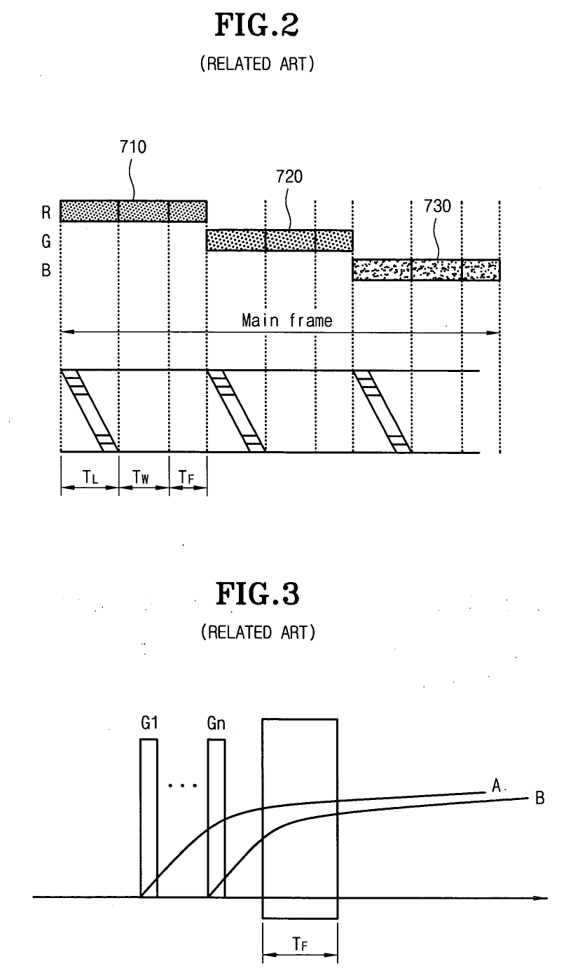

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

According to a method for driving a liquid crystal display device according to the present invention, a data loading is performed in a manner that a data addressing is performed from an upper part of a liquid crystal display panel in an odd frame, while the data addressing is performed from a lower part of the liquid crystal display panel in an even frame.

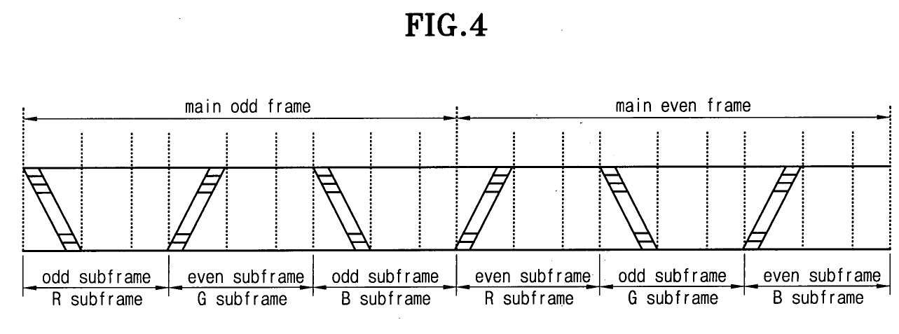

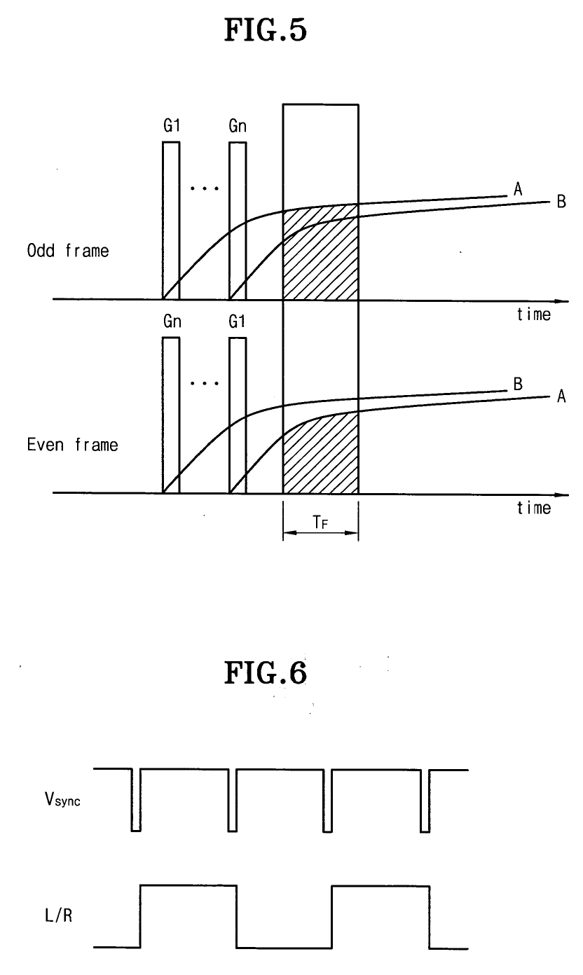

As shown in FIG. 4, the present invention minimizes the non-uniformity of luminance and chrominance occurring in upper and lower parts of the liquid crystal display panel by loading data in a “V” shape. FIG. 5 shows liquid crystal reactions according to a method for driving a liquid crystal display device according to the present invention.

With reference to FIGS. 4 and 5, the method for driving a liquid crystal display device according to the present invention will be explained in detail.

A liquid crystal display panel of the liquid crystal display device according to the present invention has an RGB LED background light source provided in the lower part thereof, a TFT array constructed on a lower substrate thereof, and common wirings and black matrices, from which RGB resins, i.e., color filters, are removed, formed on an upper substrate thereof.

In this case, the light source composed of the RGB LEDs emits lights of RGB colors, and by sequentially flashing the RGB LEDs, the colors of lights passing through the liquid crystal display panel form a white light.

One frame is divided into RGB sub-frames, and LEDs corresponding to the respective sub-frames are sequentially flashed at a flashing time.

Also, the data loading is performed in the order of R, G and B using a two-frame memory.

FIG. 4 shows the loading order of the data signal. In the main odd frame, the R sub-frame becomes an odd sub-frame, the G sub-frame becomes an even frame, and the B sub-frame becomes an odd sub-frame in a sequential manner.

By contrast, in the main even frame, The R, G and B sub-frames become even, odd and even sub-frames in a sequential manner.

Specifically, as shown in FIG. 4, in the case of the R sub-frame, if the sub-frame is odd, the data is loaded from an upper part to a lower part of the liquid crystal display panel, and the carry shift direction of the gate is set from the upper part to the lower part of the liquid crystal display panel.

Meanwhile, if the sub-frame is even, the data is loaded from the lower part to the upper part of the liquid crystal display panel, and the carry shift direction of the gate is also set from the lower part to the upper part of the liquid crystal display panel.

In this case, the transmission direction of the gate signal is changed in a manner that when a vertical sync signal Vsync is inputted to the timing controller 500, a left/right signal is changed as shown in FIG. 6. Also, the frame data is read from the memory 600 to match the order of the data.

For reference, FIG. 6 shows a shift direction changeover signal of the gate driver IC. The loading direction of the data is changed by alternately changing the left/right (L/R) signal of the gate driver IC in synchronization with the vertical sync signal Vsync of the sub-frame.

Meanwhile, FIG. 5 shows the degree of reaction of the liquid crystal with respect to the odd frame and the even frame of the R sub-frame. In the odd frame, the gate signal of the first line is applied, and the liquid crystal of the first line reacts as the data is charged in the liquid crystal.

Thereafter, if the gate signal of the second line is applied, the liquid crystal of the second line starts its reaction. If the gate signal of the last line is applied through the above-described process, the liquid crystal of the last line starts its reaction.

In the same manner, in the even frame, the gate signal of the last line is first applied, and the gates of the upper line are sequentially turned on. In this case, there is a difference in liquid crystal reaction at the LED flashing time T_{F} due to the difference in data loading time between the lines.

The degrees of reaction with respect to the odd and even frames are illustrated in FIG. 5. The luminance and the chrominance react in proportion to the degrees of reaction of the liquid crystals, i.e., areas of slanting-line parts as shown in FIG. 5.

Accordingly, the areas according to the degree of reaction of the upper and lower liquid crystals become identical with each other, and thus the non-uniformity of the upper and lower parts of the chrominance and the luminance can be relieved.

In FIG. 5, “A” indicates a liquid crystal reaction profile of the first gate line, and “B” indicates a liquid crystal reaction profile of the last gate line.

As described above, according to the present invention, the data loading to the FSC type liquid crystal display panel is changed in a manner that data is addressed from the upper part to the lower part of the liquid crystal display panel in an odd frame, and the data is addressed from the lower part to the upper part of the liquid crystal display panel in an even field, and thus the non-uniformity of luminance and chrominance appearing on the upper part and the lower part of the liquid crystal display panel, which may occur due to the low reaction speed of the liquid crystal, can be minimized.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method for driving a field sequential color (FSC) type liquid crystal display device having a liquid crystal display panel, a source driver IC for applying data signals to the liquid crystal display panel, a gate driver IC for applying gate signals to the liquid crystal display panel, a timing controller for applying various kinds of control signals and data signals to the gate and source driver ICs, and a background light source, composed of red, green and blue LEDs, for implementing RGB colors, the method comprising, in addressing data to the liquid crystal display panels according to an odd or even frame, addressing the data from an upper part to a lower part of the liquid crystal display panel in the odd frame, while addressing the data from the lower part to the upper part of the liquid crystal display panel in the even frame.

2. The method as claimed in claim 1, wherein the gate signals are sequentially applied to the liquid crystal display panel, starting from a first gate line to a last gate line, in the odd frame, while the gate signals are sequentially applied to the liquid crystal display panel, starting from the last gate line to the first gate line, in the even frame.

3. The method as claimed in claim 1, wherein a carry shift direction of gates is set to be from the upper part to the lower part of the liquid crystal display panel in the odd frame, while the carry shift direction is set to be from the lower part to the upper part of the liquid crystal display panel in the even frame.

4. The method as claimed in claim 1, wherein RGB sub-frames in the odd frame are arranged as odd, even and odd sub-frames in sequence, while the RGB sub-frames in the even frame are arranged as even, odd, and even sub-frames in sequence.

5. The method as claimed in claim 1, wherein a gate left/right signal is used as a control signal for changing a data-addressing direction, and is for alternately changing the direction in synchronization with a vertical sync signal of the sub-frames.
